(19) United States
(12) Patent Application Publication
(10) Pub. No.: US 2018/0106223 A1
(43) Pub. Date: Apr. 19, 2018

(54) System and Method for Improving Fuel Mileage of Internal Combustion Engine

(71) Applicant: Eduardas Ceremis, Lemont, IL (US)

(72) Inventor: Eduardas Ceremis, Lemont, IL (US)

(21) Appl. No.: 15/293,068

(22) Filed: Oct. 13, 2016

(51) Int. Cl. F02M 27/04; F02M 35/10

(52) U.S. Cl. CPC F02M 27/045; F02M 35/10334

(57) ABSTRACT

A modification to the air input ducting of an internal combustion engine. The engine can be gasoline, diesel or other fuel and can be located in any type of vehicle including automobiles, trucks, boats, ships, aircraft and any other vehicle. The invention includes mounting layers of very strong permanent magnets with interspersed iron or other metal structures in the air intake of the engine. The magnets are placed so that the intake air must flow between them through the strong magnetic field and at the same time contact the iron or other metal which is generally a surface layer on each magnet. The total amount of airflow is not impeded and is almost the same as when the magnets are not present. Pollution is also greatly reduced.

### BACKGROUND

### Field of the Invention

The present invention relates to the field of internal combustion engines and more particularly to a system and method for improving fuel mileage.

### Description of the Problem

It is well-known that internal combustion engines suffer from gross inefficiencies and get very poor fuel mileage. Over the years, there have been numerous suggestions and inventions aimed at improving this situation. Many of these partial solutions involve better carburetion or fuel-air mixing. Some solutions use pressure or compressed air. Vehicle computers are aimed at providing efficient mixing for various load conditions.

It would be advantageous to have a system and method that made full use of the gas components of air to provide very efficient burning with very little fuel.

### SUMMARY OF THE INVENTION

The present invention relates to a modification to the air input ducting of an internal combustion engine. The engine can be gasoline, diesel or other fuel and can be located in any type of vehicle including automobiles, trucks, boats, ships, aircraft and any other vehicle. The invention includes mounting layers of very strong permanent magnets with interspersed iron or other metal structures in the air intake of the engine. The magnets are placed so that the intake air must flow between them through the strong magnetic field and at the same time contact the iron or other metal which is generally a surface layer on each magnet. The total amount of airflow is not impeded and is almost the same as when the magnets are not present. The presence of the magnets and iron or other metal excites the air in such a way as to greatly increase combustion efficiency in the engine. Output pollution is also greatly reduced.

The main purpose of the invention is its ability to enhance the air around it as fuel for any kind of internal combustion engines such as a cars, trucks, trains, airplanes, ships, military equipment, space craft, farm equipment, and/or any other vehicles built around the use of fossil fuels such as gasoline, kerosene, diesel, and the like.

It is known that gasoline and oxygen are the only two elements participating in the burning process of fuel whereby only 30% of the fuel is being used; 70% is wasted and is polluting our air.

It is also known that the atmosphere consists of approximately 78% Nitrogen and 21% Oxygen. The present invention changes the composition and intake of the air forcing Oxygen (O2) to burn. This is accomplished without introducing ANY changes to the existing motor.

The unit is simply mounted to the outside (or inside) of an air filter that can be preinstalled by a manufacturer or by a user when mass-produced.

The present invention uses up 95-99% of any kind of fuel in the tank emitting 95-99% of clean air into the atmosphere. There is very little waste, and the vehicle drives 50%-70% further on the same tank of fuel!

### DESCRIPTION OF THE FIGURES

Attention is now directed to several figures that illustrate features of the present invention.

FIG. 1 shows a prior art air intake system for an internal combustion engine.

FIG. 2 shows an embodiment of the present invention using a single pair of magnets.

FIG. 3 shows an embodiment of the present invention using layers of magnets.

Several illustrations have been presented to aid in understanding the present invention. The scope of the present invention is not limited to what is shown in the figures.

### DESCRIPTION OF THE PREFERRED EMBODIMENTS

The present invention relates to a system and method for reducing fuel usage in internal combustion engines. It has been found experimentally, that if the air intake system to the engine is modified by placing a pair or multiple pairs of very strong permanent magnets in the airflow and forcing the air to flow between the magnets through the magnetic field, the engine may be run efficiently in a very lean fuel mode. The effect is enhanced if each magnet it coated with a thin layer of metallic iron.

The preferred magnets are neodymium; however, any very strong magnets are within the scope of the present invention. The magnets are placed generally horizontally in pairs in the air intake system with the north pole of a first magnet aligned with a south pole of a second magnet. Each magnet can have a thin coating of metal different from the metal from which it is made from approximately 0.5 mm to 2.0 mm thick on the surface that faces the other magnet in the pair. The preferred metal is iron, and the preferred thickness is approximately 1.5 mm. All the airflow is forced to flow through the magnetic field between the magnets and over the iron or other metal surfaces.

As an example of field strength, it is known that a neodymium magnet disk 1 inch in diameter and ½ inch thick produces a field strength of around 4674 Gauss. Larger neodymium magnets can produce much stronger fields. The effect of the present invention is enhanced as magnetic field strength is increased. Therefore, magnets should be used that produce the greatest field strength possible.

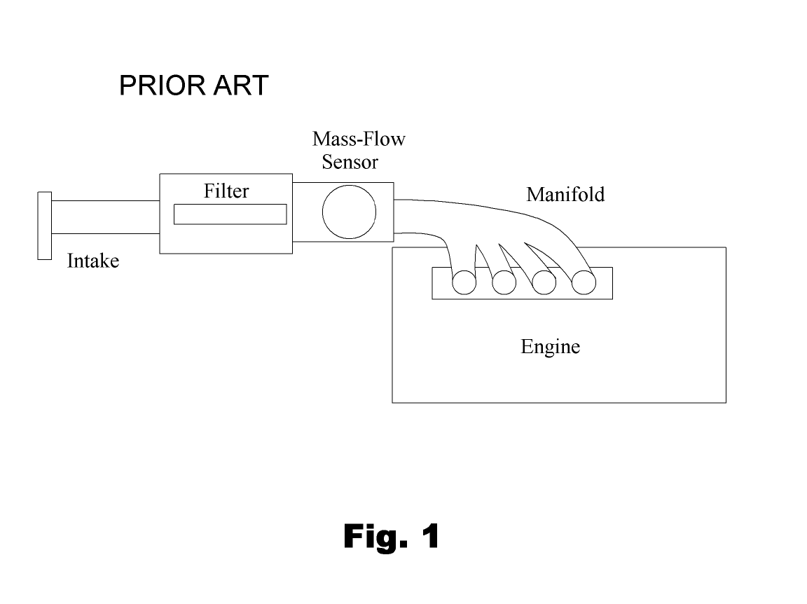

FIG. 1 shows a prior art conventional air intake system for an internal combustion engine. Air flows through an air filter in a usually plastic box past a mass flow sensor that reports airflow to a computer. There is also a throttle valve (not shown) that can close off the airflow or allow it depending on the desired engine RPM.

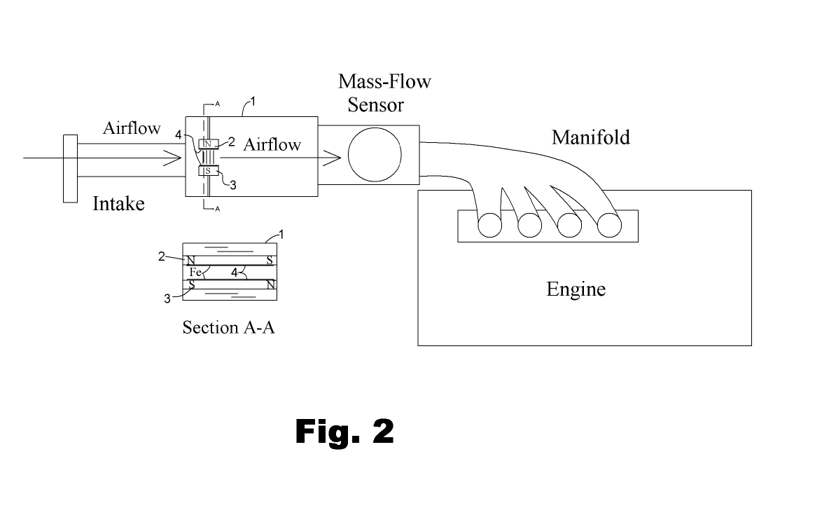

FIG. 2 shows an embodiment of the present invention with a single pair of magnets. A box 1, which can be the same box that holds the air filter or a different compartment contains two very strong permanent magnets 2, 3 that are mounted in the box with the north pole of the top magnet aligned with the south pole of the bottom magnet. This creates a region of very strong field lines all along the magnets. FIG. 2 shows a side view with Section A-A showing a front view. Each magnet 2, 3 is coated with a thin layer of iron 4. While iron is preferred, it is also possible to use other ferro-metals, or other catalyst metals such as platinium. In the working system, it is important to not choke off the airflow with the magnets. Therefore, the total space between the magnets should be large enough to allow maximum required airflow. This should usually not be less than 80% of the original possible airflow.

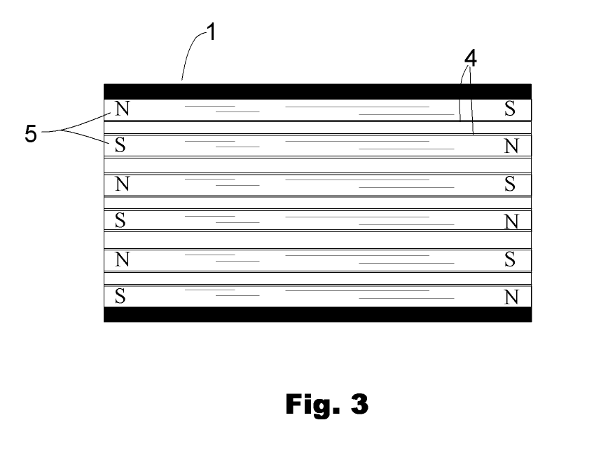

For some engines, it is not possible to space the magnets close enough together to achieve a large magnetic field, and still maintain maximum possible airflow. This is especially true for diesel engines. FIG. 3 shows an alternate embodiment of the present invention that includes layers of magnet pairs 5 mounted in a box 1, each pair having an iron coating 4 on the surfaces of the magnets that face other magnets.

The exact phenomena that causes the enhancement effect is not well understood. A Russian scientist named Andreev published a treatise several years ago attempting to explain a similar effect (although he used platinum). He concluded that nitrogen and oxygen molecules in the air were being broken down. He also concluded that it was possible to have combustion using only air. His resulting theory has not been totally verified. The effect nevertheless is to cause all of the fuel to combust, and to not form undesirable compounds such as CO, S and NOx compounds.

The present inventor has found through experimentation with several different motor vehicles that the embodiments of the invention shown herein do work. Test vehicles can be run in very lean fuel configurations with greatly improved fuel mileage. It has been observed that without the magnets (iron only), there is no improvement, and magnets alone (without the iron) provide only a marginal improvement. The use of the iron layer in combination with the very strong magnetic fields greatly increases the effect.

It should be noted that the magnets and the iron layers are not heated. If the iron is somehow acting as a catalyst, it is doing it at normal vehicle intake air temperatures. Heating the magnets in fact would be undesirable if they were heated beyond their Curie point temperature (thus losing their magnetic properties).

The present invention has been experimentally verified to provide marked increased in fuel mileage apparently obtained by taking maximum energy out of a very lean fuel air mixture. The air passing between the magnets and near the iron enters some type of excited state that vastly enhances combustion. Exactly what that state is has not yet been experimentally determined.

The present invention provides a system and method to tremendously enhance fuel mileage of any internal combustion engine that uses air while greatly reducing pollution by reducing the amount of undesirable byproducts of the combustion that are exhausted into the atmosphere by the engine.

The following test was run on a particular vehicle:

The vehicle was a 1998 Mercedes Benz ML 320 SUV.

| original: | with device: |
|---|---|
| 1. city- 13-14 MPG | 24-26 MPG |
| 2. mixed 15-16 MPG | 26-28 MPG |
| 3. highway 17-18 MPG | 34-35 MPG |

Several descriptions and illustrations have been presented to aid in understanding the present invention. One with skill in the art will realize that numerous changes and variations may be made without departing from the spirit of the invention. Each of these changes and variations is within the scope of the present invention.

1. A system that enhances fuel mileage of an internal combustion engine comprising:
an enclosure constructed to be placed inline with an air intake system of a vehicle having an internal combustion engine, the air intake system having a mass flow sensor;
the enclosure containing two parallel elongated permanent bar magnets, each having a north magnetic pole and a south magnetic pole, each bar magnet traversing the enclosure, the two bar magnets separated by one another forming a passage between the bar magnets; each of the bar magnets having its north pole aligned with the south pole of the other magnet;
each of the bar magnets having a coating of iron approximately 1.5 mm thick over a surface that faces the other magnet;
the enclosure being located in the air intake system upstream from the mass-flow sensor.

2. The system of claim 1 wherein the enclosure is an air filter enclosure.

3. The system of claim 1 wherein the enclosure is between an air filter and the mass flow sensor.

4. The system of claim 1 wherein the passage is at least 80% of the cross-sectional area of the enclosure.

5. The system of claim 1 wherein there are multiple pairs of magnets spaced to allow intake air to flow between them.

6. The system of claim 1 wherein the air intake system has a particular total cross-sectional area, and wherein the magnets block a cross-sectional area of no greater than 20% of the particular total cross-sectional area.

7-16. (canceled)

17. A system that enhances fuel mileage of an internal combustion engine comprising:
an enclosure constructed to be placed inline with an air intake system of a vehicle having an internal combustion engine, the air intake system having a mass flow sensor;
the enclosure containing a plurality of parallel elongated permanent bar magnets, each having a north magnetic pole and a south magnetic pole, each bar magnet traversing the enclosure, the bar magnets separated by one another forming a plurality of passages between the bar magnets; each of the bar magnets having its north pole aligned with the south pole of the other magnet;
each of the bar magnets having a coating of iron approximately 1.5 mm thick over a surface that faces the other magnet;
the enclosure being located in the air intake system upstream from the mass-flow sensor.

18. The system of claim 17 wherein the enclosure is an air filter enclosure.

19. The system of claim 17 wherein the enclosure is between an air filter and the mass flow sensor.

20. The system of claim 17 wherein the passage is at least 80% of the cross-sectional area of the enclosure.

21. A system that enhances fuel mileage of an internal combustion engine comprising:
an enclosure constructed to be placed inline with an air intake system of a vehicle having an internal combustion engine, the air intake system having a mass flow sensor;
the enclosure containing a plurality of parallel elongated permanent bar magnets, each having a north magnetic pole and a south magnetic pole, each bar magnet traversing the enclosure, the bar magnets separated by one another forming a plurality of passages between the bar magnets; each of the bar magnets having its north pole aligned with the south pole of the other magnet;
each of the bar magnets being made of a first metal, the first metal having permanent magnetic properties, and each magnet having a coating of a second metal, the second metal not having permanent magnetic properties, the coating being approximately 1.5 mm thick over a surface that faces the other magnet;
the enclosure being located in the air intake system upstream from the mass-flow sensor.

22. The system of claim 21 wherein the second metal is iron.

23. The system of claim 21 wherein the first metal is neodymium.
